(19) United States
(12) Patent Application Publication
(10) Pub. No.: US 2010/0158423 A1
(43) Pub. Date: Jun. 24, 2010

(54) BEARING UNIT, PREFERABLY, WHEEL BEARING UNIT FOR A MOTOR VEHICLE, AND METHOD FOR PRODUCING A BEARING UNIT

(75) Inventor: Erwin Hartmann, Bergrheinfeld (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (unknown)

(21) Appl. No.: 12/090,120

(22) PCT Filed: Sep. 29, 2006
(86) PCT No.: PCT/DE06/01729

§ 371 Date: Apr. 14, 2008

(30) Foreign Application Priority Data
Oct. 15, 2005 (DE) 10 2005 049 454.4

(51) Int. Cl. F16C 13/00; B23P 17/00

(52) U.S. Cl. 384/544; 29/898.06

(57) ABSTRACT

The invention relates to a bearing unit comprising a hub provided with a wheel-sided securing flange, whereon an angular contact anti-friction bearing is arranged. In order to produce the bearing unit and to operate it in an economical manner, and also to prevent, for example, deformation and tensions characteristic of known roller riveting units, the securing flange is connected in a material fit to the flange ring in relation to the end of the hub, which clamps at least the inner ring to the hub. The invention also relates to a method for producing a bearing unit, preferably, a wheel bearing unit for a motor vehicle, comprising a hub which is provided with a wheel-sided securing flange whereon an angular contact anti-friction bearing comprising at least one inner ring and an outer ring, is arranged, by means of a device which exerts a clamping force on the bearing unit.

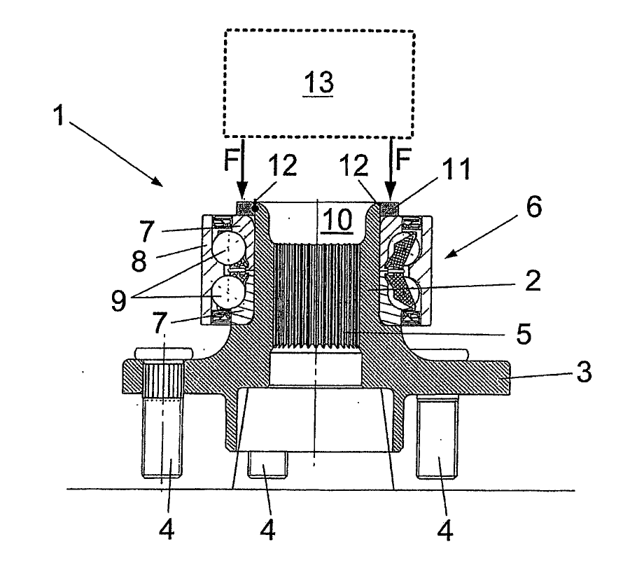

### FIELD OF THE INVENTION

The invention relates to a bearing unit, preferably a wheel bearing unit for a motor vehicle, having a hub with a wheel-side fastening flange on which is arranged an angular-contact rolling bearing with at least one inner ring and an outer ring. The invention also relates to a method for mounting a bearing unit of said type, by means of a device which exerts a clamping force on the bearing unit.

### BACKGROUND OF THE INVENTION

Wheel bearings are highly loaded parts in particular for wheel suspensions on the chassis of a motor vehicle which must withstand a very wide variety of operating loads.

One important component of the overall wheel bearing assembly are its bearing inner rings which, after heat treatment processes and cutting steps, are axially fixed with a correspondingly high clamping force −50 kN to 120 kN depending on the bearing size.

Known devices and methods for setting an axial clamping force of said type are bracing the wheel flange by means of a joint bell, a nut on the wheel flange or a rolling rivet collar generated by means of a rolling rivet process using a rolling rivet unit.

A rolling rivet collar of said type is generated by means of cold working by means of rolling rivets on the hub end of the wheel bearing, with an outwardly curved bead for fixing the inner ring to the hub being formed there.

DE 43 39 847 C2 shows a generic wheel bearing unit for motor vehicles, composed of a hub and an angular-contact rolling bearing in which at least one inner ring is axially fixed by means of a bead which is generated by means of plastic cold working by means of rolling rivets in a rolling rivet machine and which bead is integrally formed on the hub end.

The bead has, as viewed in cross section, a curvature which extends in the direction of the outer periphery and which is inclined with respect to the inner ring. Of significance for the generation of the inner ring clamping force are the dimension of the projecting length of the initially undeformed bead, the inner ring edge shortening geometry, the tool profile for the axial bead outer shape, and the rolling rivet force. Narrow tolerances and precise dimensions are therefore necessary.

The generation of the rolling rivet collar for a correspondingly high clamping force inevitably results in an additional radial widening of the rolling-rivet-side inner ring rim; there is a direct relationship between rolling rivet force and radial rim widening.

Product-related measures such as thickened inner ring cross section and shaping of the edge shortening or flange throat (bead) permit only a limited reduction of the radial inner ring rim widening. In order to ensure the component function, additional measures such as special heat treatment, machining steps or an interference fit during the rolling riveting are necessary, which make the design and the process more expensive.

In order to produce a curved (rolling rivet) bead of said type for axially fixing the at least one bearing inner ring, DE 196 13 441 A1 discloses a method for producing a rolling bearing unit, in particular a wheel bearing for motor vehicles, composed of a plurality of individual parts, with one bearing ring being braced against a shaft shoulder or two adjacently-arranged bearing rings being braced against one another and being held together by means of a cold-worked bead or collar.

For this purpose, as the bearing rings are pushed onto the hub, as the bearing rings abut against an axial inner ring stop face, and during the cold working of the bead, the force-travel profile is determined and compared with predefined values by means of an electronic measuring device. In the event of deviations from the predefined force-travel profile, the deviation is introduced as a regulating variable into a force-controlled shaping machine, for example a wobble press.

Said method is complex to implement since it requires a technical monitoring cycle with associated electronic components. It is also disadvantageous that deformation of the bead takes place as a result of the cold working and, as a result, stresses occur which generally necessitate further production-related working steps in order to eliminate said stresses. On account of the high degree of shaping variance, rolling rivet units of said type are also subject to high degrees of scatter with regard to the required clamping forces.

### OBJECT OF THE INVENTION

The invention is based on the object of creating a bearing unit, preferably a wheel bearing unit for a motor vehicle, of the type specified in the introduction, and a production method for a bearing unit of said type which generates a precise clamping force with a low degree of variance, avoids widening problems, for example deformations and stresses as in the case of known rolling rivet units, and can be produced and operated in a cost-effective manner,

### SUMMARY OF THE INVENTION

The invention is based on the realization that cold working of thick-walled cross sections with relatively small diameters (ratio of wall thickness to diameter of bore 0.2 to 0.08), in particular by means of rolling rivet processes and rolling rivet units, usually leads to undesired additional radial deformations and stresses at the rolling-rivet-side inner ring rim, which can adversely affect the function and reliability of the bearing unit.

The invention is therefore based on a bearing unit, preferably a wheel bearing unit for a motor vehicle, having a hub with a wheel-side fastening flange on which is arranged an angular-contact rolling bearing with at least one inner ring and one outer ring. It is additionally provided that that end of the hub which is situated opposite from the fastening flange is connected in a materially joined fashion to a flange ring which braces at least the inner ring with the hub.

By means of said construction, a materially joined connection of the angular-contact rolling bearing to the hub of the bearing unit is obtained by means of two components, specifically the connection of that end of the hub which is situated opposite from the fastening flange to a flange ring.

The at least one inner ring of the angular-contact rolling bearing is thereby connected to the hub of the bearing unit by means of the flange ring without additional radial deformations and/or stresses at the flange-ring-side inner ring.

The solution according to the invention can be used in wheel bearings of all designs for motor vehicles, in particular in wheel bearings which are to have a preset inner ring clamping force, without further modifications or additional expenditure being necessary at the wheel bearing.

It can advantageously also be provided that that end of the hub which is situated opposite from the fastening flange is welded to the flange ring. That end of the hub which is situated opposite from the fastening flange is preferably connected to the flange ring by means of laser welding.

By means of the laser welding process, a non-contact, thermally low-loading and precise welding process is used which has a low beam divergence with a high beam energy and good focusability and, as a tool, is not subject to any wear.

The invention is also based on a method for producing a bearing unit, preferably a wheel bearing unit for a motor vehicle, having a hub with a wheel-side fastening flange on which are arranged an angular-contact rolling bearing with at least one inner ring and one outer ring, by means of a device which exerts a clamping force on the bearing unit, in particular on the at least one inner ring and/or on the hub of the bearing unit.

In said method, after the fitting of the angular-contact rolling bearing onto the hub, a flange ring is placed onto the end of the hub which is situated opposite from the fastening flange. By means of the device, a clamping force plus a spring-back force component, in particular the spring-back force component of the hub and/or of the flange ring, is subsequently exerted on the bearing unit, in particular on the at least one inner ring and/or on the hub of the bearing unit, and in the meantime, the flange ring is connected in a materially joined fashion to the end of the hub which is situated opposite from the fastening flange.

With said method, it is possible to adhere to a precise and uniform clamping force with low variance for the clamping force for mass production.

The invention additionally permits the use of two symmetrical identical inner rings—for the case that two inner rings for the angular-contact rolling bearing are provided—since a geometric edge shortening can be dimensioned solely according to strength requirements on the side of the fastening flange.

The flange-ring-side edge shortening could likewise be designed to be very small in order to reduce a bending moment as a result of the axial clamping force, in contrast to rolling rivet units in which the formation of the edge shortening has a direct influence on the shaping behavior of the bead integrally formed on the hub end.

The method according to the invention also permits the setting of a clamping force of any desired definition on the bearing unit or on the at least one inner ring without additional radial widening problems, as generally occur in the known rolling rivet units, for example the occurrence of high degrees of scatter on account of the high level of shaping variance.

Precise adherence to the clamping force is also made possible by means of a precisely meterable pressing force. The exertion of the clamping force plus the spring-back component, in particular the spring-back component of the hub (flange partial deflection) and/or of the flange ring—with a spring characteristic curve or characteristic curves of the hub and/or of the flange ring being known, from which the spring-back component can be determined—particularly advantageously acts on the bearing unit, which is not adversely affected by means of deformations of the materials used or stresses in the materials.

It is also provided that, after finishing the connecting process, the clamping force exerted by the device is removed, with the bearing unit, in particular the inner ring, relaxing, in particular by a magnitude of the flange partial deflection or of the hub spring-back force component and/or of the flange ring spring-back force component, into the desired bearing clamping force.

According to a further embodiment of the method according to the invention, the end of the hub which is situated opposite of the fastening flange is welded to the flange ring. The end of the hub which is situated opposite from the fastening flange is preferably connected to the flange ring by means of laser welding. In the process, no deformations and/or stresses occur when using the laser welding process.

### BRIEF DESCRIPTION OF THE DRAWINGS

The invention is explained in more detail below on the basis of the appended drawing of an embodiment. In said drawing, the FIGURE of the drawing shows a sectioned view of a wheel bearing unit according to the invention which has been mounted as per the method according to the invention.

### DETAILED DESCRIPTION OF THE DRAWINGS

The wheel bearing unit 1 has a hub 2 with a wheel-side fastening flange 3 to which a friction body (not illustrated), specifically a brake disk and a wheel rim, are fastened by means of connecting elements 4, for example screws.

The hub 2 can be connected, by means of an internal toothing 5 in its interior, in a rotationally fixed manner to a driven joint shaft axle, as is conventional for driven axles.

In the case (not illustrated) of hubs for non-driven axles, the hub is formed at the inside without elements for torque transmission and can be of massive, solid design or formed with cutouts.

An angular-contact rolling bearing 6, which is in this case of double-row design, is arranged on the hub 2, which angular-contact rolling bearing 6 has a two-part inner ring 7 and an outer ring 8 between which are arranged two rings of spherical rolling bodies 9.

End 10 of the hub 2 which is situated opposite from the fastening flange 3 is connected in a materially joined fashion to a flange ring 11, specifically by means of welding and preferably by means of laser welding at the inner periphery, denoted by 12, of the flange ring 11, so that the adjoining inner ring 7 is braced with the hub 2 by a preload force.

As explained below, the production and mounting of said wheel bearing unit 1 takes place using a clamping force F which acts on the wheel bearing unit 1 and which is applied by the schematically illustrated device 13.

After the angular-contact rolling bearing 6 is pushed axially onto the hub 2, the flange ring 11 is placed onto end 10 of the hub 2 which is situated opposite from the fastening flange 3. By means of the device 13, the clamping force F plus a spring-back force component of the hub 2 (flange deflection) and of the flange ring 11, is subsequently exerted on the wheel bearing inner rings 7.

The spring-back component is determined here from the known spring characteristic curves of the hub 2 and of the flange ring 11, which can for example be determined before the production process.

At the same time, the flange ring 11 is connected by means of a welding process, preferably by means of laser welding, in a materially joined fashion and free from additional radial widenings or stresses in the inner rings 7, to the end 10 of the hub 2 which is situated opposite from the fastening flange 3.

After the end of the welding process, the clamping force F exerted by the device 13 on the wheel bearing inner rings 7 is removed. In the process, the wheel bearing inner rings 7 relax, by the magnitude of spring-back of the hub 2 and of the flange ring 11, into the desired bearing clamping force.

### List of Reference Symbols

1 Wheel bearing unit

2 Hub

3 Fastening flange

4 Connecting element

5 Internal toothing

6 Angular-contact rolling bearing

7 Inner ring

8 Outer ring

9 Rolling bodies

10 Hub end

11 Flange ring

12 Weld point

13 Device

F Clamping force

1. A bearing unit, preferably a wheel bearing unit for a motor vehicle, comprising: a hub with a wheel-side fastening flange on which is arranged an angular-contact rolling bearing with at least one inner ring and an outer ring wherein an end of the hub is situated opposite from the fastening flange, the hub being connected in a materially joined fashion to a flange ring which braces at least the inner ring with the hub.

2. The bearing unit as claimed in claim 1, wherein the end of the hub which is situated opposite from the fastening flange is welded to the flange ring.

3. The bearing unit as claimed in claim 1 wherein the end of the hub which is situated opposite from the fastening flange is connected to the flange ring by means of laser welding.

4. A method for producing a bearing unit, preferably a wheel bearing unit for a motor vehicle, having a hub with a wheel-side fastening flange on which is arranged an angular-contact rolling bearing with at least one inner ring and an outer ring comprising the steps of: exerting a clamping force on the bearing unit by means of a device, in particular on the inner ring or on the hub of the bearing unit wherein, after fitting the angular-contact rolling bearing onto the hub, a flange ring is placed onto an end of the hub which is situated opposite from the fastening flange; exerting a clamping force plus a spring-back force component by means of the device, in particular a spring-back force component of the hub or of the flange ring, on the bearing unit, in particular on the inner ring or on the hub of the bearing unit; and connecting the flange ring in a materially joined fashion to the end of the hub which is situated opposite from the fastening flange.

5. The method as claimed in claim 4, further comprising the steps of: after the end of the connecting process, removing the clamping force exerted by the device, with the bearing unit, in particular the inner ring, relaxing, in particular by a magnitude of a flange partial deflection or of the hub spring-back force component or of the flange ring spring-back force component, into the desired bearing clamping force.

6. The method as claimed in claim 4, further comprising the steps of: welding the end of the hub which is situated opposite from the fastening flange to the flange ring.

7. The method as claimed in claim 4, further comprising the steps of: laser welding the end of the hub which is situated opposite from the fastening flange is connected to the flange ring.
